(19) United States
(12) Patent Application Publication
(10) Pub. No.: US 2006/0190990 A1
(43) Pub. Date: Aug. 24, 2006

(54) Method and system for controlling access to a service provided through a network

(76) Inventors: Shimon Gruper, Haifa (IL); Yanki Margalit, Ramat-Gan (IL); Dany Margalit, Ramat-Gan (IL)

Correspondence Address: DR. MARK FRIEDMAN LTD.;C/o Bill Polkinghorn, 9003 Florin Way, Upper Marlboro, MD, 20772, US

(21) Appl. No.: 11/062,820

(22) Filed: Feb. 23, 2005

(51) Int. Cl. H04L 9/32

(52) U.S. Cl. 726/3

(57) ABSTRACT

The present invention is directed to a method for controlling access of a user to a service provided through a network, and a system thereof. The method comprising the steps of: upon initiating a connection of the user to the network, authenticating the user; upon positively authenticating the user, creating or updating a cookie within the workstation of the user, the cookie comprising information related to access permission of the user to the service; upon requesting to access the service by the user, retrieving the information from the cookie by a gateway to the network, and enforcing the access permission on the user.

### FIELD OF THE INVENTION

The present invention relates to the field of data networks. More particularly, the present invention relates to a method and system for controlling access of a user to a service provided through a network, e.g. accessing a URL, email, etc.

### BACKGROUND OF THE INVENTION

Nowadays it is common to limit the access of users to the Web. The limitation may be enforced to certain users, type of users (e.g. guests and members), to specific Web sites, to specific types of Web sites (e.g. sex sites), to certain Web services (e.g. email), and so forth. Organizations find special interest in limiting the Internet access of their users, since by conducting unlimited access permission to Web sites, the users of the organization gets exposed to viruses and other forms of malicious objects.

Typically, a local area network comprises a gateway server, a file server and network nodes (e.g. individual user computers). Sometimes, a proxy server is also connected to a local area network, in order to allow an organization to employ security tests, administrative control, etc.

Usually, upon getting connected to a network, a user gets a unique IP address upon which he is identified while being connected to the network. Typically the IP address is selected from a pool or a range of IP addresses. A gateway server can address a user only by its IP address, however since usually an IP addresses remains the same only for one session, associating an IP address with a user has a temporary nature. As a result, providing different access level to different users of a network is an obstacle.

It is an object of the present invention to provide a method and system for associating a user/workstation with its session IP address.

It is a further object of the present invention to provide a method and system for associating a user/workstation with an IP address, which enables conducting an access level on individual basis.

It is a still further object of the present invention to provide a method and system for associating a user with an IP address, which restricts the access of a user/workstation to a service provided through a network according to its access level.

It is a still further object of the present invention to provide a method and system for controlling access of a user/workstation to a service provided through a network.

Other objects and advantages of the invention will become apparent as the description proceeds.

### SUMMARY OF THE INVENTION

In one aspect, the present invention is directed to a method for controlling access of a user to a service provided through a network, the method comprising the steps of: upon initiating a connection of the user to the network, authenticating the user; upon positively authenticating the user, creating or updating a cookie within the workstation of the user, the cookie comprising information related to access permission of the user to the service; upon requesting to access the service by the user, retrieving the information from the cookie by a gateway to the network, and enforcing the access permission on the user.

In another aspect, the present invention is directed to a method for controlling access of a user to a service provided through a network, the method comprising the steps of: upon initiating a connection of the user to the network, authenticating the user; upon positively authenticating the user, creating or updating a cookie within the computer of the user, the cookie comprising information related to access permission of the user to the service; on a gateway to the network, upon requesting to access the service during a connection session by the user, retrieving by the gateway information stored within the cookie, and adding the information and the current IP address of the user to a logged-in list; on the gateway, upon requesting by a user to re-access the service, identifying the user by his IP address, retrieving the record of the user from the list, and enforcing the access permission on the user.

In yet another aspect, the present invention is directed to a system for controlling access of a user to a service provided through a network, the system comprising: a cookie on a workstation of the user, for storing information related to an access permission of the user or workstation to the service; a local server, for authenticating the user and launching a login script for creating the cookie on the workstation, the cookie comprising information related to access permission of the user to the service; a program executed on a gateway of the network, for checking the permission of the user to access the service according to information stored within the cookie, and enforcing the access permission of the user to the service according to the result of the checking.

The information may be about specified access permission of the user to the service, the identity of the user that can be associated with an access permission of the user to the service, and so forth.

The access permission may be related to accessing a certain Web site, accessing Web sites of a certain type, accessing Web sites of a certain category, accessing a certain domain, an access level associated with certain access permissions, and so forth.

The service may be accessing a URL, antivirus service, downloading a file, downloading a certain type file, downloading active content, downloading certain type of active content, accessing encrypted content, using a user's credentials from a cookie to decrypt the content, and so forth.

According to one embodiment of the invention, the service is available through a network such as Internet, WAN, LAN, etc.

### BRIEF DESCRIPTION OF THE DRAWINGS

The present invention may be better understood in conjunction with the following figures:

FIG. 1 is a block diagram of a computing environment in which the present invention may be used.

FIG. 2 is a flowchart of a login process to a network, according to a preferred embodiment of the present invention.

FIG. 3 is a flowchart of a process of retrieving a Web page from a remote server, according to a preferred embodiment of the present invention.

FIG. 4 is a flowchart of a process of retrieving a Web page from a remote server, according to another preferred embodiment of the present invention.

### DETAILED DESCRIPTION OF PREFERRED EMBODIMENTS

The present invention now will be described more fully and clearly hereinafter with reference to the following figures, in which preferred embodiments of the invention are shown. The invention may, however, be embodied in many different forms and should not be limited to what is illustrated in the drawings; rather, these embodiments are provided so that the disclosure of the invention will be thorough, and its scope will be better understood to those skilled in the art.

In order to facilitate the description to come, the following terms are defined:

The term Gateway refers in the art as to a bridge between two networks. It is often associated with both a router, which knows where to direct a packet of data that arrives to the gateway, and a switch, which furnishes the actual path in and out of the gateway for a packet.

The term Proxy Server refers in the art to a server that intermediates between a user's workstation and the Internet (or other network). By the means of a proxy server an organization can employ a security policy to the network, conduct administrative control, authenticate its users, etc.

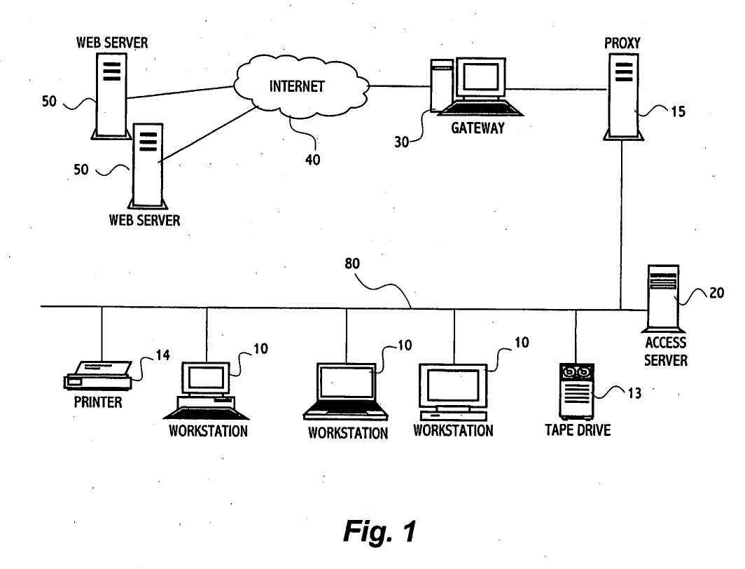

FIG. 1 is a block diagram of a computing environment in which the present invention may be used. Workstations 10 are connected by a line bus 80. Additional equipment may also be connected to the network, such as I/O devices, which in this case are illustrated by tape drive 13, and printer 14. The network also includes one or more servers 20, which may be used for several services. Server 20 is referred herein as to Access server, and its role is explained hereinafter. Web servers 50, which are in charged of operating Web sites, are accessible to gateway 30 through the Internet 40.

Typically, every device logged into a network gets a unique IP address upon which the device can be addressed by other devices connected to the local network. The IP address of the objects connected to the network are not permanent. When a device logs into a network, the device gets an IP address which is determined dynamically by a dedicated server. The dedicated server assigns an IP address from a pool of IP addresses or from a range of IP addresses. This is carried out by DHCP (Dynamic Host Configuration Protocol).

When the user of a workstation 10 browses a Web site operated by one of the Web servers 50, the communication packets exchanged between the a workstation 10 and the Web server 50 have to pass through the gateway 30, however the only information the gateway has on the identity of the user is his current IP address, which is not permanent, as explained hereinabove. Therefore a gateway cannot implement an access policy for a certain user.

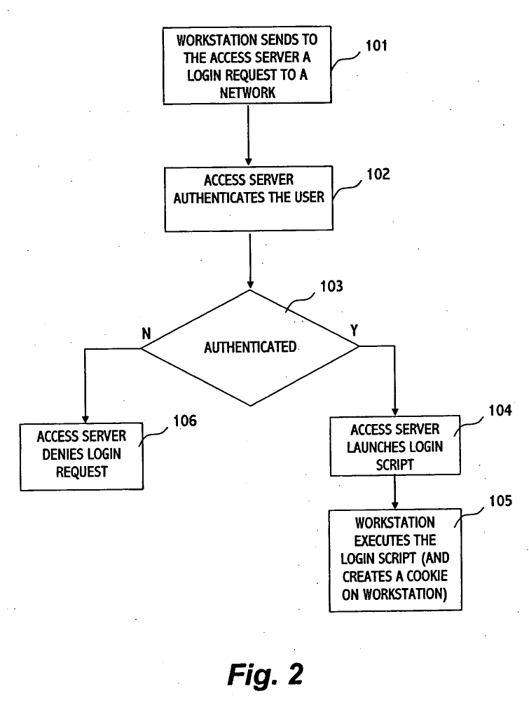

FIG. 2 is a flowchart of a login process to a network, according to a preferred embodiment of the present invention.

At block 101, a workstation (e.g. user's machine 10 of FIG. 1) sends to the access server (e.g. access server 20 on FIG. 1) a request for a service, e.g. to login into the Internet.

At block 102, the access server authenticates the workstation/user.

From block 103, if the workstation/user is not authenticated, then at block 106 the login is denied, otherwise flow continues at block 104.

At block 104 the access server launches a login script, i.e. sends to the workstation instruction(s) to be performed by the workstation in order to create or update a cookie on the workstation.

According to one embodiment of the invention, the cookie comprises at least information related to the access permission of the user/workstation to the requested service, i.e. Internet. For example, the information may specify allowed/forbidden Web sites (e.g. exclude porno Web sites, allow only certain Web sites, etc.), etc. According to another embodiment of the invention, the cookie comprises at least information about the identity of its user/workstation, which can be associated with access permission of the user/workstation to service(s) by a predefined list. Of course the data stored within the cookie may contain other information, if needed. The association of the identity of the user with access permissions

At block 105 the workstation executes the login script, i.e. creates or updates a cookie on the workstation of the user, which as mentioned above comprises at least information about the access permission of the user to the service, which in this case is the Internet.

The term Cookie refers in the art to data stored at a user's workstation and accessible by a Web server. Typically cookies are used by Web sites as means for keeping track of a user's preferences. A cookie actually is a solution for two contradicting necessities. On the one hand the access to user's workstation should be prevented when the user is connected to a network (e.g. Internet) in order to prevent from unauthorized objects to access the user's workstation. On the other hand, a remote server, e.g. an Internet server, may need to access to the user's workstation, for example for storing his preferences when browsing a Web site. The cookie technology bridges between these contradicting necessities. Browsers, which actually execute a set of instructions provided from a remote server (e.g. an HTML file) are programmed to allow access to cookies on the user's workstation, although the access to other resources of the user's workstation may be restricted.

It should be noted that since the access server 20 is a part of a local area network 80, the access server 20 has less limitations on accessing resources of a workstation 10 (e.g. its hard drive), as workstation 10 is connected to the same local area network. However, the gateway 30, as being an external object to the local area network 80, has restrictions on accessing the resources of a workstation 10. Nevertheless, since the gateway server can access cookies within a workstation 10, it can access the cookie created by the access server 20 at the login stage of the workstation 10 to the network, thereby overcoming the obstacle.

It should be also noted that cookies used by the present invention can be hidden or encrypted, in order to prevent from unauthorized objects to access the information stored within a cookie.

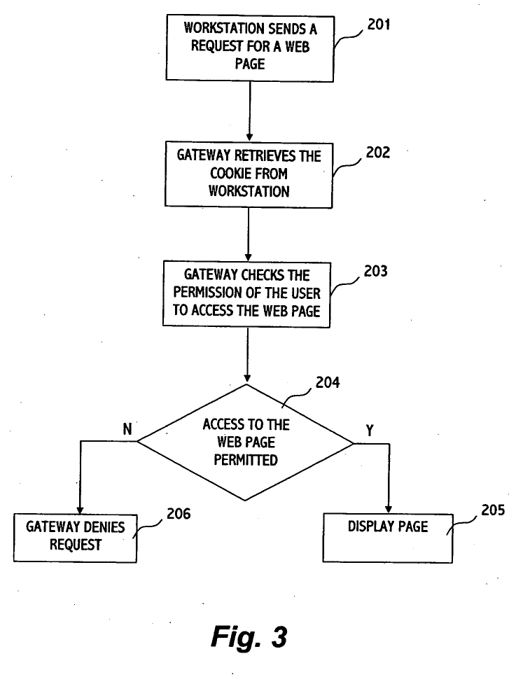

FIG. 3 is a flowchart of a process of retrieving a Web page from a remote server, according to a preferred embodiment of the present invention.

At block 201, a workstation sends a request to the gateway for a Web page. It should be noted that although the examples herein refer to a Web page, the example is valid also to a Web site or any other service provided through a network.

At block 202, the gateway retrieves the cookie from the workstation 10. The data stored within the cookie specifies at least the user/workstation's access permission to the requested service.

At block 203, the gateway checks the permission of the workstation/user to access the requested service, which in this case is a Web page.

From block 204, if the access to the Web page is permitted to the workstation/user, then the flow continues to block 205, where the Web page is retrieved and displayed on the workstation's display; otherwise, the flow continues to block 206, where the gateway denies the request for the Web page.

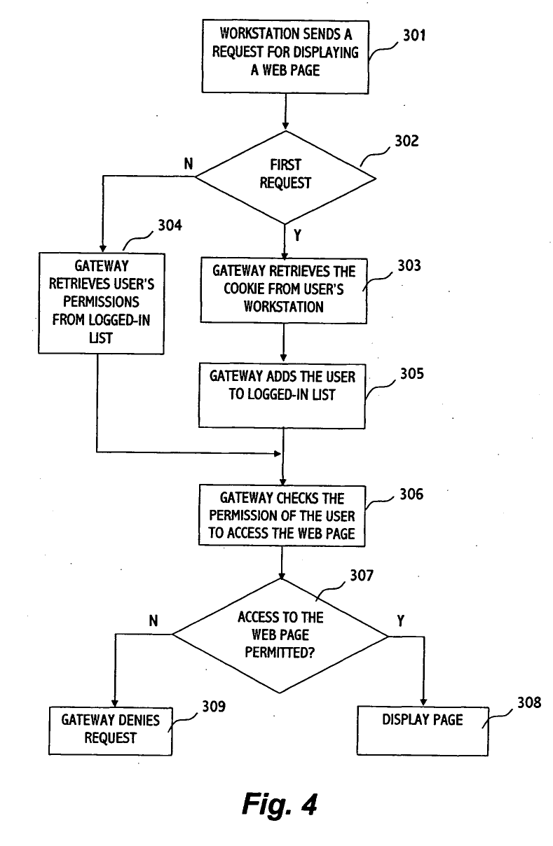

FIG. 4 is a flowchart of a process of retrieving a Web page from a remote server, according to another preferred embodiment of the present invention.

At block 301, a workstation sends a request to the gateway for a service, e.g. to get a certain Web page.

From block 302, if it is the first request of this session where the workstation asks to access a Web page, then the flow continues with block 303, where the gateway retrieves the cookie from the user's workstation, and then the flow continues with block 305 where the gateway adds the details retrieved from the cookie to a list of logged-in users, including the current IP address. The logged-in list maintains information about the permission to access service(s), etc. When a user logs out of the network (or gets disconnected, etc.) then his record is removed from the list. If it is not the first request in the current session of a user to access to a Web page, then the flow continues with step 304, where the gateway retrieves the user's permission(s) from the logged-in list, in contrast to the embodiment of FIG. 3, where the gateway retrieves the information from the cookie. This way the access to the Web page is faster, since the operation of getting information from a remote location (i.e. the cookie) takes more time than retrieving information from a local location (i.e. the logged-in list).

As mentioned above, at the gateway the identity of the user is unknown, since a user addresses the gateway only by its IP address. However, since the user is associated with the same IP address during the entire connection session, and since the record of the user on the logged-in list comprises the IP address which has assigned to the user for the current connection session, the gateway can associate the user with his IP address, and by this information to retrieve his details from the logged-in list.

At block 306, the permission of the user/workstation to access the requested Web page is checked.

From block 307, if the access to the Web page is permitted to the workstation/user, then the flow continues to block 308, where the Web page is retrieved and displayed on the workstation's display; otherwise, the flow continues to block 309, where the gateway denies the request for the Web page.

It should be noted that according to the present invention, some functionalities of a proxy server are carried out by the gateway, and accordingly an operator of a local area network may discard the proxy server from his system.

Typically access permissions are defined to the system (access server or gateway) by an authorized person such as a supervisor or administrator.

According to one embodiment of the invention, when an anonymous user (i.e. a user which has not been authorized to access the local area network) attempts to login to the local area network, the server launches a login script, which creates a cookie at the user's workstation. The cookie grants to the user a “guest level” by which the user does not have permission to access certain services, e.g. the Internet in general, or certain Web sites.

Those skilled in the art will appreciate that the invention can be embodied by other forms and ways, without losing the scope of the invention. The embodiments described herein should be considered as illustrative and not restrictive. Although specific terms are employed herein, they are used in a generic and descriptive sense only and not for purposes of limitation.

What is claimed is:

1. A method for controlling access of a user to a service provided through a network, the method comprising the steps of:
upon initiating a connection of said user to said network, authenticating said user and creating or updating a cookie within the workstation of said user, said cookie comprising information related to access permission of said user to said service, said access permission corresponds to the result of said authenticating;
upon requesting to access said service by said user, retrieving said information from said cookie by a gateway to said network, and enforcing said access permission on said user.

2. A method according to claim 1, wherein said cookie is stored in an encrypted form.

3. A method according to claim 1, wherein said information is selected from a group comprising: specified access permission of said user to said service; identity of said user, for associating with an access permission of said user to said service.

4. A method according to claim 1, wherein said access permission is selected from the group comprising: accessing a certain Web site, accessing Web sites of a certain type, accessing Web sites of a certain category, accessing a certain domain, and an access level associated with at least one certain access permission.

5. A method according to claim 1, wherein said service is available through a network selected from the group comprising: Internet, WAN, LAN.

6. A method according to claim 1, wherein said service is selected from the group comprising: accessing a URL, antivirus service, downloading a file, downloading a certain type file, downloading active content, downloading certain type of active content, accessing encrypted content, using a user's credentials from a cookie to decrypt the content.

7. A method for controlling access of a user to a service provided through a network, the method comprising the steps of:
upon initiating a connection of said user to said network, authenticating said user and creating or updating a cookie within the workstation of said user, said cookie comprising information related to access permission of said user to said service, said access permission corresponds to the result of said authenticating;
at a gateway to said network, upon requesting to access said service during a connection session by said user, retrieving by said gateway information stored within said cookie, and adding said information and a current IP address of said user to a logged-in list;
at said gateway, upon requesting by a user to re-access said service, identifying said user by said current IP address, retrieving said information of said user from said list according to said current IP address, and enforcing said access permission on said user.

8. A method according to claim 7, wherein said access permission is selected from the group comprising: an access level, an allowed or forbidden Web site, an allowed or forbidden type of Web sites, an allowed or forbidden category of Web sites, and an allowed or forbidden domain.

9. A method according to claim 7, wherein said service is available through a network selected from the group comprising: Internet, WAN, LAN.

10. A method according to claim 7, wherein said service is selected from the group comprising: accessing a URL, antivirus service, downloading a file, downloading a certain type file, downloading active content, downloading certain type of active content, accessing encrypted content, using a user's credentials from a cookie to decrypt the content.

11. A system for controlling access of a user to a service provided through a network, the system comprising:
a local server, for authenticating said user and launching a login script for creating a cookie on said workstation, said cookie comprising information related to access permission of said user to said service;
a program executed on a gateway of said network, for checking the permission of said user to access said service according to information stored within said cookie, and enforcing said access permission of said user to said service according to the result of said checking.

12. A system according to claim 11, wherein said information is selected from a group comprising: specified access permission of said user to said service, identity of said user that can be associated with an access permission of said user to said service.

13. A system according to claim 11, further comprising a list of logged-in users, each entry of said list comprising an identifier of a logged-in user, and at least one permission of said user to access said service.

14. A system according to claim 13, wherein said identifier is selected from a group comprising: an IP address of said user for the current connection session, a user name.

15. A system according to claim 11, wherein said access permission is selected from the group comprising: an access level, an allowed or forbidden Web site, an allowed or forbidden type of Web sites, an allowed or forbidden category of Web sites, and an allowed or forbidden domain.

16. A system according to claim 11, wherein said service is available through a network selected from the group comprising: Internet, WAN, LAN.

17. A system according to claim 11, wherein said service is selected from the group comprising: accessing a URL, antivirus service, downloading a file, downloading a certain type file, downloading active content, downloading certain type of active content, accessing encrypted content, using a user's credentials from a cookie to decrypt the content.
